(19) United States
(12) Patent Application Publication
(10) Pub. No.: US 2024/0095436 A1
(43) Pub. Date: Mar. 21, 2024

(54) METHOD AND DEVICE FOR AUTOMATIC VERIFICATION OF PIN MULTIPLEXING

(71) Applicant: Black Sesame Technologies Co., Ltd., Wuhan (CN)

(72) Inventor: Qingyun Zhong, Shanghai (CN)

(73) Assignee: Black Sesame Technologies Co., Ltd., Wuhan (CN)

(21) Appl. No.: 18/369,556

(22) Filed: Sep. 18, 2023

(30) Foreign Application Priority Data
Sep. 19, 2022 (CN) 202211139817.8

(51) Int. Cl. G06F 30/398

(52) U.S. Cl. CPC G06F 30/398

(57) ABSTRACT

Embodiments of the present disclosure provides a method and a device for automatically verifying full chip pin multiplex, equipment, and a storage medium. The method comprises obtaining pin information that comprises a pin functional attribute and pin multiplex information; generating an automatic verification process for pins based on the pin information; and automatically verifying the pins one by one according to the automatic verification process generated for the pins. Hence, the system can reduce the workload of verification, improve verification efficiency, and reduce omission of vulnerabilities.

### RELATED APPLICATION

This application claims the benefit under 35 U.S.C. § 119(a) of the filing date of Chinese Patent Application No. 202211139817.8, filed in the Chinese Patent Office on Sep. 19, 2022. The disclosure of the foregoing application is herein incorporated by reference in its entirety.

### FIELD

The present disclosure relates to the technical field of SOC (System on Chip) verification, and particularly, to a method and a device for automatically verifying chip pin multiplexing.

### BACKGROUND

At present, with increasing complexity of SOC chips and more and more functional modules therein, chip technology is improving, area of chips is decreasing. However, the number of chip pins is limited. Therefore, pin multiplex technology is adopted to meet the above requirements, that is, the same pin may be used for different functions in different usage scenarios.

As for chip verification, manually writing a verification case based on design requirements may result in a significant workload and errors. In addition, as design requirements constantly change, pin functions change correspondingly, causing necessary modifications to verification code in batches, which further increases the workload. Moreover, it is easy to hide a large number of vulnerabilities in the code, resulting in low reusability of the verification code.

The number of pins may also lead to certain erroneous association between pins. And, when verifying a certain function, if only multiplex pins are checked, without checking the remainder, omitting design defects may also be caused.

### SUMMARY

Embodiments of the present disclosure provide a method and a device for automatically verifying full chip pin multiplex, equipment, and a storage medium, which enables to improve completeness in chip verification to a certain extent.

An embodiment of the present disclosure provides a method for automatically verifying full chip pin multiplex, which includes obtaining pin information that includes a pin functional attribute and pin multiplex information; generating an automatic verification process for pins based on obtained pin information; and automatically verifying the pins one by one according to the automatic verification process generated for the pins.

An embodiment of the present disclosure provides a device for automatically verifying full chip pin multiplex, which includes a pin information acquisition module for obtaining pin information that includes a pin functional attribute and pin multiplex information; an automatic verification process generation module for generating an automatic verification process for pins based on the pin information, wherein the automatic verification process includes a test sequence process and/or a check sequence process; and a pin verification module for automatically verifying the pins one by one according to the automatic verification process for the pins.

An embodiment of the present disclosure provides a non-transient computer readable storage medium, which stores a computer instruction for enabling a computer to execute the method for automatically verifying full chip pin multiplex as described above.

An embodiment of the present disclosure provides electronic equipment, which includes a memory, a processor, and a computer program stored in the memory and executable on the processor, wherein the processor executes the program to achieve the method for automatically verifying full chip pin multiplex as described above.

According to the embodiments of the present disclosure, a verification process with high reusability is written, thereby greatly reducing the workload of verification, improving verification efficiency, and reducing omission of vulnerabilities. Moreover, all pins are tested and checked simultaneously, which enables to troubleshoot connection errors between different pins, achieving full pin verification, and improving completeness in verification.

### BRIEF DESCRIPTION OF THE DRAWINGS

In order to provide a clearer explanation of the technical solution in the embodiments of the present disclosure, a brief introduction will be given below to the accompanying drawings required in the description of the embodiments. It is obvious that, the accompanying drawings in the following description are only some embodiments of the present invention, and other accompanying drawings may also be obtained based thereon without creative labor for those skilled in the art.

FIG. 1 is a schematic view of a single pin multiplex configuration relationship according to an embodiment of the present disclosure.

FIG. 2 is a schematic view of a method for automatically verifying full chip pin multiplex according to an embodiment of the present disclosure.

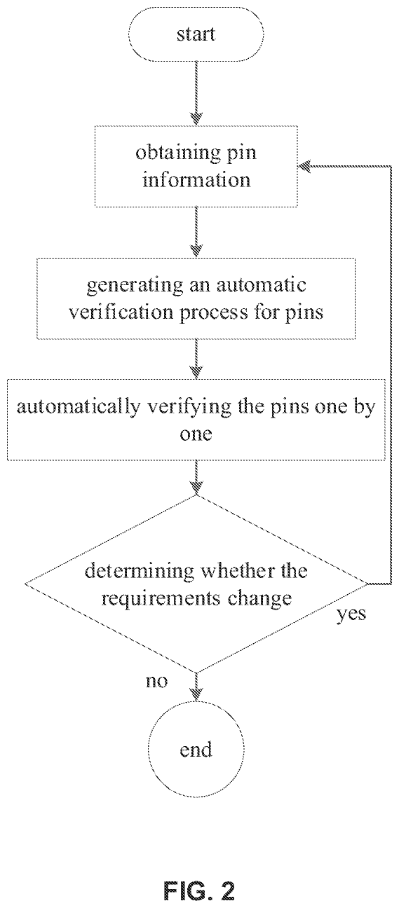

FIG. 3 is a schematic flowchart of automatically verifying pins one by one according to an embodiment of the present disclosure.

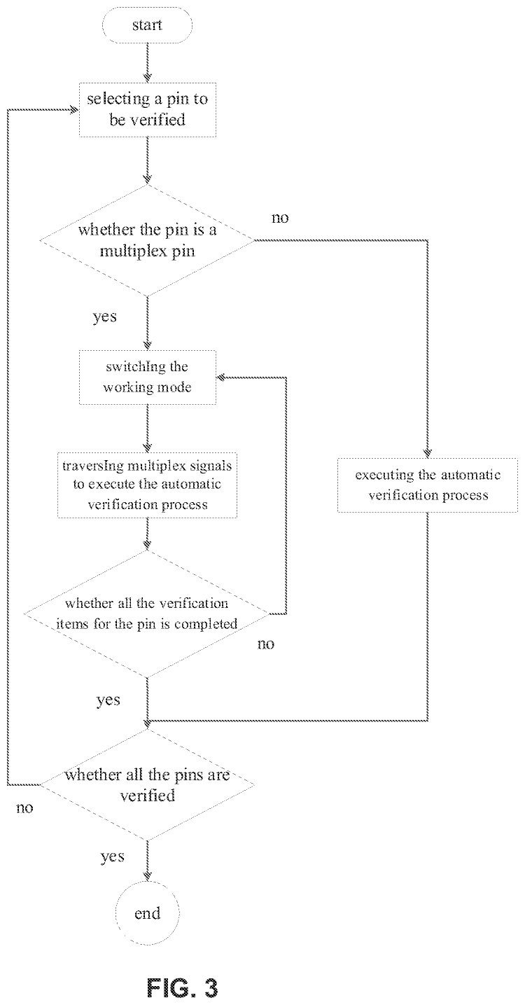

FIG. 4 is a schematic flowchart of a method for automatically verifying full chip pin multiplex according to an embodiment of the present disclosure.

FIG. 5 is a schematic module view of a device for automatically verifying full chip pin multiplex according to an embodiment of the present disclosure.

### DETAILED DESCRIPTION OF EMBODIMENTS

The embodiments of the present disclosure will be described clearly and completely in the following in conjunction with the accompanying drawings. Obviously, the embodiments to be described are only a part but not all of the embodiments. Based on the embodiments provided in the present disclosure, all other embodiments obtained by those skilled in the art without creative labor fall within the scope of protection of the present disclosure.

It should be noted that, unless otherwise defined, the technical or scientific terms used in the embodiments of the present disclosure should have the usual meaning understood by those with general skills in the field to which the present disclosure belongs. The “first”, “second”, and similar words used in the embodiments of the present disclosure do not indicate any order, quantity, or importance, but are only used to distinguish different components. The “include” or “comprise” and other similar words means that, the elements or items that appear before the words cover the elements or items listed after the words and their equivalents, without excluding other elements or items. The “connection” or “connected” and other similar words are not limited to physical or mechanical connection, but may include electrical connection, whether being direct or indirect. The terms “up”, “down”, “left”, “right”, etc. are only used to represent relative positional relationships. And, when the absolute position of the described object changes, the relative positional relationships may also change accordingly.

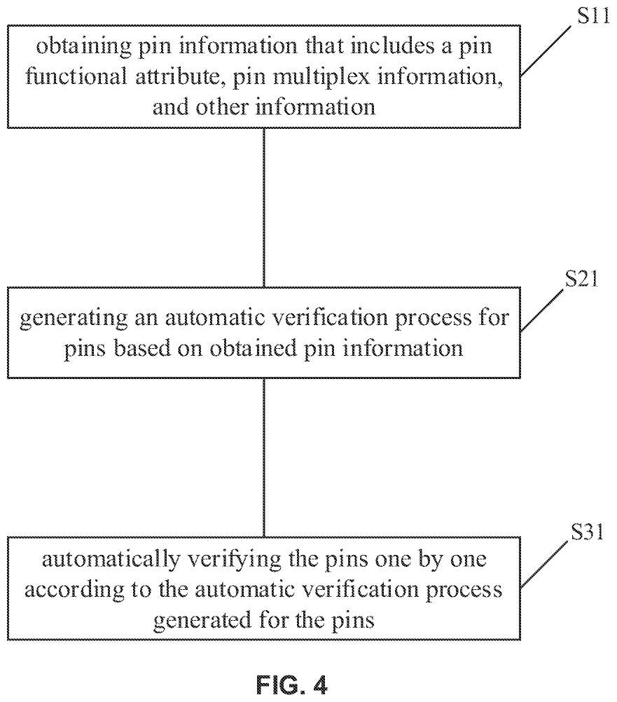

Please refer to FIG. 4, the present disclosure provides a method for automatically verifying full chip pin multiplex, which may be applied to electric equipment for verifying a chip, and may include the following steps.

S11. obtaining pin information that includes a pin functional attribute, pin multiplex information, and other information.

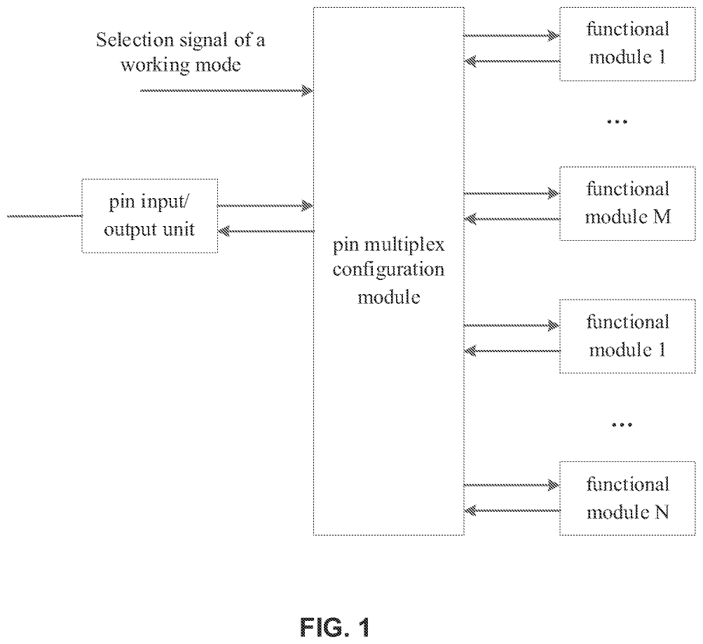

FIG. 1 is a schematic view of a configuration relationship of a single pin multiplex. As shown in FIG. 1, a pin multiplex configuration module (also known as signal multiplex configuration module, Pin Mux) is connected to a pin input/output unit (IO PAD CELL) and a functional module, respectively. The pin multiplex configuration module consists of several independent subunits, each of which processes signal multiplex for one pin, sets output of a specific pin, and receives an input signal of a pin. Before reaching each pin input/output unit, signals of a plurality of functional modules are selected for multiplex. And, for a certain function of a chip, each pin has only one functional attribute accordingly. Thus, different multiplexed signals may be selected or switched by configuring a register in the pin multiplex configuration module.

Working mode of a chip is divided into a normal functional mode and a test mode, which are selected based on an enable signal of the test mode.

According to some embodiments, a script program is used to automatically extract the pin information from a pin multiplex design table (also known as signal multiplex table). The pin information may include a pin functional attribute, pin multiplex information, and other information. The pin functional attribute may include a pin direction attribute, a pin pull-up/down attribute, and the like. The pin multiplex information may include whether the functional mode is multiplex, a non-multiplexed signal hierarchy path, a multiplexed signal M (an input/output attribute, an input hierarchy path, an output hierarchy path, an output enable hierarchy path), a register (default value) in the pin multiplex configuration module, whether the test mode is multiplex, a multiplexed signal N in the test mode (an input/output attribute, an input hierarchy path, an output hierarchy path, an output enable hierarchy path), and the like. The other information may include a pin name, a control register (default value) for the pin input/output unit (IO PAD CELL), and the like. An example of the pin multiplex design table is shown in Table 1 below.

TABLE 1

| | | | | | | | | | | |
|---|---|---|---|---|---|---|---|---|---|---|
| Pin | Pin | Pin | . . . | A | A | . . . | Whether | A | A | . . . |
| names | directions | pull-up/ | | multiplexed | multiplexed | | the | multiplexed | multiplexed | |
| | | down | | signal 0 | signal 1 | | test | signal | signal | |
| | | attributes | | in the | in the | | mode | 0 in the | 1 in the | |
| | | | | functional | functional | | is | test mode | test mode | |
| | | | | mode | mode1 | | multiplex | | | |

In the multiplex design table, there are M signal multiplexes in the functional mode. And, a port signal may be selected by a user through configuring the register of the pin multiplex configuration module according to requirements. When M is 1, it indicates that the signal, such as clock, reset, test mode enable and other signals, has not been multiplexed, and is connected directly to the pin input/output unit (IO PAD CELL). When M is greater than 1 and less than the maximum multiplex number of a multiplex selection unit, there is a situation where the multiplexed signal in the multiplex design table is blank, and it is generally by default output-disable.

In the multiplex design table, there are N signal multiplexes in the test mode. Different test modes may be selected based on a selection signal of the test mode. And, the chip may only work in one test mode at a time.

S21. generating an automatic verification process for pins based on obtained pin information.

The automatic verification process may include a test sequence section, in which a test sequence is generated based on the pin functional attribute. A standard functional attribute of a chip pin may include direction attributes and pull-up/down attributes. The direction attributes may be divided into three types, that is, input only, output only, and input/output. Among them, there is only one input signal for the input only, and only one output signal for the output only (the output enable is always valid), as well as one input signal, one output signal, and one output enable signal for the input/output. The pull-up/down attributes may have three states, that is, high level, low level, and high impedance. An automatic test sequence may define four test sequence states based on the direction attributes and the pull-up/down attributes, so as to apply excitation. The four test sequence states may be PAD_TO_MODULE_0, PAD_TO_MODULE_1, MODULE_TO_PAD_0, and MODULE_TO_PAD_1. When one of the four test sequence states is completed in giving a value, an IDLE state is entered.

Test sequences for all pins may be automatically generated based on the direction attribute of each pin obtained from the pin multiplex design table.

Specifically, if the pin has a direction attribute of input only, or the selected multiplexed signal is an input only signal, the pull-up/down attribute of the pin may be first determined. If pull-up, input is level 1; pull-down, input is level 0; and no pull, which is high impedance, the input signal is unstable. The level 0 or level 1 is then applied from the pin input/output unit side, to obtain two test sequence states of PAD_TO_MODULE_0 and PAD_TO_MODULE_1. For a test in an input only attribute, the level 0 may be applied from PAD, and the state is updated to PAD_TO_MODULE_0, and to IDLE after a period of time. Then, after a period of time, the level 1 is applied, and the state is updated to PAD_TO_MODULE_1, and to IDLE after a period of time. Subsequently, after a period of time, the level 0 is applied, and the state is updated to PAD_TO_MODULE_0, and to IDLE after a period of time. Finally, after a period of time, a given value on PAD is released.

If the pin has a direction attribute of output only, or the selected multiplexed signal is an output only signal, the output enable is always valid, and the level 0 or level 1 is applied from the functional module side to obtain two test sequence states of MODULE_TO_PAD_0 and MODULE_TO_PAD_1. For a test in an output only attribute, the level 0 may be applied from MODE, and the state is updated to MODULE_TO_PAD_0, and to IDLE after a period of time. Then, after a period of time, the level 1 is applied, and the state is updated to MODULE_TO_PAD_1, and to IDLE after a period of time. Subsequently, after a period of time, the level 0 is applied, and the state is updated to MODULE_TO_PAD_0, and to IDLE after a period of time. Finally, after a period of time, a given value of a path on MODE is released.

For an input output attribute, the output enable may be first turn off to test the input, and then turned on to test the output, with the same test sequence as above.

According to some embodiments, each pin may be assigned to one test sequence number, TEST_SEQ_NUM, ranging from 0 to (the total number of the pins −1) with an initial value of 0, that is, the test is started from the first pin. For each pin, it is determined whether the current test sequence number is the same as the test sequence number of the pin. If it is the same, the pin will enter the test sequence process. And, when the test sequence is completed for the pin, the test sequence number will be TEST_SEQ_NUM+1, until the automatic verification process for all pins is completed.

According to some embodiments, the automatic verification process for pins may further include a check sequence section for checking all pins and troubleshooting connection errors between different pins. A check sequence may be automatically generated for all pins based on the multiplex information of each pin obtained from the pin multiplex design table. The check sequence is to determine whether values of each pin are consistent with values of all multiplexed signals thereof throughout the normal functional mode and the test mode.

When a current test sequence number is different from a test sequence number of a pin, the pin will enter the check sequence process. In a non-IDLE state of the test sequence, and based on the test mode enable and multiplex selection register and test pin multiplex configuration module signal, it is determined whether the value of the pin is consistent with the value of the multiplexed signal M in the functional mode or the value of the multiplexed signal N in the test mode. If not, it indicates that there is a connection error between different pins.

It should be understood that, assuming the total number of pins is n, when the current test sequence number is the same as the test sequence number of an i^{th} pin, this pin enters the test sequence process, and the remaining n−1 pins enter the check sequence process, which are executed in parallel. After the test sequence is completed for this pin, the test sequence number will be TEST_SEQ_NUM+1, and will undergo the automatic verification process for all pins with updated test sequence numbers. Every update on the test sequence number or the test sequence state may trigger a check on all pins.

As mentioned above, since the automatic verification process includes the test sequence section generated based on the functional attributes of the pins, and the check sequence section determined based on a desired value obtained from the pin multiplex design table, the automatic verification process may be applicable to any chip pins and has reusability.

S31. automatically verifying the pins one by one according to the automatic verification process generated for the pins.

In the pin multiplex design table, each pin may include two working modes, that is, the normal functional mode and the test mode. The normal functional mode may include M multiplexed signals. And, the test mode may include N multiplexed signals.

The specific automatic verification process on the pins one by one may be as follows. For a certain pin, an enable signal of the test mode is turned off first, and the normal functional mode is selected as the working mode. In addition, a multiplexed signal M is selected by a register in the pin multiplex configuration module, so as to complete the automatic verification process in step S21 including a test sequence process and/or a check sequence process based on the direction attribute of the multiplexed signal M, until all multiplexed signals in the normal functional mode are traversed. Then, the enable signal of the test mode may be turned on to switch the working mode to the test mode. And, a test multiplexed signal N is selected by a register in the pin multiplex configuration module, so as to complete the test in step S21 based on the direction attribute of the multiplexed signal N, until all multiplexed signals in the test mode are traversed. By analogy, all pins may be traversed one by one to perform the automatic verification, so as to complete in the normal functional mode and the test mode, with ensuring correctness. Moreover, an automatic extraction of information in the pin multiplex design table using the script program enables to automatically extract information that meets verification requirements when the chip verification requirements change, further reducing the workload of verification, and improving verification efficiency.

According to some embodiments, when a certain pin is tested, the remaining pins are checked synchronously. That is, the test sequence process and the check sequence process are executed in parallel on all pins.

According to some embodiments, step S31 may further include step S32. determining whether the pin is a multiplex pin. The obtained pin information includes whether the pin is a multiplex pin. If the pin is a non-multiplex pin, a signal is directly connected to the pin input/output unit, to bypass configuring the register of the pin multiplex configuration module, and directly verify by the test sequence and/or the check sequence.

If the pin is a multiplex pin, the signal is connected to the pin input/output unit after passing through the pin multiplex configuration module. And, the register of the pin multiplex configuration module is configured to verify by the test sequence and/or the check sequence for all multiplexed signals.

According to some embodiments, after step S31, the method may further include step S41. determining whether the pin multiplex design table is updated, and if updated, retrieving the pin information and repeating steps S11 to S31.

In the case that verification requirements change and the pin multiplex design table is updated, it is only necessary to reuse the script program to automatically extract information that meets the verification requirements, to import the extracted information into the verification case to regress the case. Thereby, improving verification efficiency and reducing omission of verification vulnerabilities.

It should be noted that, the method according to the embodiments of the present disclosure may be executed by a single device, such as a computer or a server, or may also be applied in distributed scenarios to be completed by a plurality of devices working together. In a case of such distributed scenarios, one of the plurality of devices may only execute one or more steps in the method according to the embodiments of the present disclosure, and the plurality of devices will interact with each other to complete the method.

It should be noted that, the above describes some embodiments of the present disclosure. Other embodiments are within the scope of the attached claims. In some cases, the actions or steps recited in the claims may be executed in a different order from the above embodiments to still achieve the desired results. In addition, the process depicted in the accompanying drawings does not necessarily require a specific or continuous shown sequence to achieve the desired results. In some embodiments, multitasking and parallel processing are also possible or may be advantageous.

As mentioned above, the embodiments of the present disclosure may achieve the following beneficial effects.

By writing a highly reusable verification process, workload of verification is greatly reduced, efficiency of verification is improved, and omission of vulnerabilities is reduced. Moreover, the automatical extraction of information in the pin multiplex design table using the script program enables to automatically extract information that meets the verification requirements when the chip verification requirements change, further reducing workload of verification and improving verification efficiency.

By testing and checking all pins simultaneously, it is possible to troubleshoot connection errors between different pins, achieving full pin verification, and improving completeness in verification.

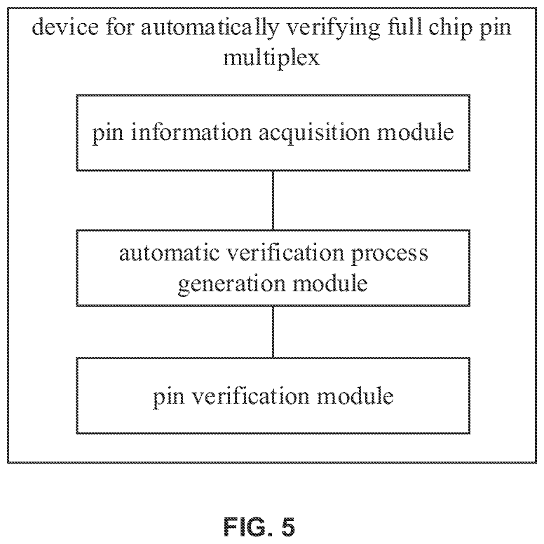

Please refer to FIG. 5, based on the same inventive concept and corresponding to any of the aforementioned embodiments, the present disclosure further provides a device for automatically verifying full chip pin multiplex, which includes a pin information acquisition module, an automatic verification process generation module, and a pin verification module.

The pin information acquisition module is used for obtaining pin information that includes a pin functional attribute, pin multiplex information, and other information. According to some embodiments, a script program is used to automatically extract the pin information from a pin multiplex design table (also known as signal multiplex table). The pin information may include a pin functional attribute, pin multiplex information, and other information. The pin functional attribute may include a pin direction attribute, a pin pull-up/down attribute, and the like. The pin multiplex information may include whether the functional mode is multiplex, a non-multiplexed signal hierarchy path, a multiplexed signal M (an input/output attribute, an input hierarchy path, an output hierarchy path, an output enable hierarchy path), a register (default value) in the pin multiplex configuration module, whether the test mode is multiplex, a multiplexed signal N in the test mode (an input/output attribute, an input hierarchy path, an output hierarchy path, an output enable hierarchy path), and the like. The other information may include a pin name, a control register (default value) for the pin input/output unit (IO PAD CELL), and the like.

The automatic verification process generation module may generate the automatic verification process for pins based on the pin information. The automatic verification process may include a test sequence process and/or a check sequence process. The automatic verification process for pins is the same as in other embodiments.

The pin verification module may automatically verify the pins one by one according to the automatic verification process for the pins. The automatic verification may include the test sequence process and/or the check sequence process.

An obtained pin information may include whether a pin is a multiplex pin. If the pin is a non-multiplex pin, a signal is directly connected to the pin input/output unit, to bypass configuring the register of the pin multiplex configuration module, and directly verify by the test sequence and/or the check sequence.

If the pin is a multiplex pin, the signal is connected to the pin input/output unit after passing through the pin multiplex configuration module. And, the register of the pin multiplex configuration module is configured to verify by the test sequence and/or the check sequence for all multiplexed signals.

In the pin multiplex design table, each pin may include two working modes, that is, a normal functional mode and a test mode. The normal functional mode may include M multiplexed signals, and the test mode may include N multiplexed signals.

For a certain pin, an enable signal of the test mode is turned off first, and the normal functional mode is selected as the working mode. In addition, a multiplexed signal M is selected by a register in the pin multiplex configuration module, so as to complete the test sequence process based on the direction attribute of the multiplexed signal M, until all multiplexed signals in the normal functional mode are traversed. Then, the enable signal of the test mode may be turned on to switch the working mode to the test mode. And, a test multiplexed signal N is selected by a register in the pin multiplex configuration module, so as to complete the test sequence process based on the direction attribute of the multiplexed signal N, until all multiplexed signals in the test mode are traversed. By analogy, all pins may be traversed one by one to perform the automatic verification, so as to complete the verification items for all pins in the normal functional mode and the test mode, with ensuring correctness.

According to some embodiments, when a certain pin is tested with the test sequence process, the remaining pins are checked synchronously with the check sequence process. That is, the test and the check are executed in parallel on all pins.

If it is found that the pin multiplex design table is updated, the pin information acquisition module will retrieve the pin information, the automatic verification process generation module will regenerate the automatic verification process, and the pin verification module will execute a regenerated automatic verification process based on a retrieved pin information, so as to verify the pins one by one until all pins are automatically verified.

For convenience of description, the above devices are described with various modules divided based on their functions, respectively. Of course, in implementing this disclosure, the functions of the various modules may be achieved in the same one or more software and/or hardware.

The device in the above embodiments is used to achieve the corresponding method for automatically verifying full chip pin multiplex in any one of the above embodiments, and has the beneficial effects corresponding to the method, which will not be elaborated here.

Based on the same inventive concept and corresponding to the method according to any of the aforementioned embodiments, the present disclosure further provides electronic equipment, which includes a memory, a processor, and a computer program stored in the memory and executable on the processor, wherein the processor executes the program to achieve the method for automatically verifying full chip pin multiplex according to any of the embodiments described above.

The processor may be a commonly used CPU (Central Processing Unit), microprocessor, Application Specific Integrated Circuit (ASIC), or one or more integrated circuits to execute related programs to achieve the technical solution provided in the embodiments of the present disclosure.

The memory may be implemented in a form of ROM (Read Only Memories), RAM (Random Access Memories), static storage devices, dynamic storage devices, or the like. The memory may store operating systems and other application programs. When implementing the technical solution provided in the embodiments of the present disclosure through software or firmware, a relevant program code is saved in the memory and called and executed by the processor.

It should be noted that, although the above equipment only includes the processor and the memory, in a specific implementation process, this equipment may also include other components necessary for normal operation. In addition, it should be understood by those skilled in the art that, the above equipment may only include the necessary components to realize the embodiments of the present disclosure, without necessarily including all the components shown in the figure.

The electronic equipment according to the above embodiments is used to realize the corresponding method for automatically verifying full chip pin multiplex in any of the above embodiments, and has the beneficial effects corresponding to the method according to the embodiments, which will not be elaborated here.

Based on the same inventive concept and corresponding to the method according to any of the aforementioned embodiments, the present disclosure further provides a non-transient computer readable storage medium, which stores a computer instruction for enabling a computer to execute the method for automatically verifying full chip pin multiplex as described in any one of the above embodiments.

The computer readable storage medium in this embodiment includes permanent, non-permanent, movable and non-movable media, and information storage thereof may be achieved by any methods or technologies. The information may be computer readable instructions, data structures, program modules, or other data. Examples of the storage medium may include, but are not limited to, phase change random access memories (PRAMs), static random access memories (SRAMs), dynamic random access memories (DRAMs), other types of random access memories (RAMs), read-only memories (ROMs), electrically erasable programmable read-only memories (EEPROMs), flash memory or other memory technologies, read-only optical disk read-only memories (CD-ROMs), digital versatile discs (DVDs) or other optical storages, magnetic cassette tapes, magnetic tape and magnetic disk storages or other magnetic storage devices, or any other non-transmission media, which may be used to store information that may be accessed by a computing device.

The computer instruction stored in the storage medium of the above embodiments is used to enable a computer to execute the method for automatically verifying full chip pin multiplex as described in any of the above embodiments, and has the beneficial effects corresponding to the method according to the embodiments, which will not be elaborated here.

It should be understood by those skilled in the art that, the discussion of any of the above embodiments is only illustrative and not intended to imply that the scope of this disclosure (including claims) is limited by these embodiments. Under the concept of this disclosure, in the above embodiments or different embodiments, the technical features may also be combined, and the steps may be implemented in any order. And, there are many other changes in different aspects of the embodiments of the present disclosure as described above, which are not provided in detail for clarity.

In addition, to simplify the explanation and discussion, and to avoid making the embodiments of the disclosure difficult to be understood, well-known power/ground connections with integrated circuit (IC) chips and other components may or may not be shown in the accompanying drawings. In addition, the devices may be shown in the form of block diagrams to avoid making the embodiments of the present disclosure difficult to be understood, and this also takes into account the fact that the details of the embodiments of devices in these block diagrams are highly dependent on the platform on which the embodiments of the present disclosure are to be implemented (i.e., these details should be fully within the understanding range of those skilled in the art). In the case where specific details (such as circuits) have been explained to describe the exemplary embodiments of the present disclosure, it is obvious to those skilled in the art that, the embodiments of the present disclosure may be implemented without these specific details or with changes in these specific details. Therefore, these descriptions should be considered explanatory rather than restrictive.

Although the present disclosure has been described in conjunction with specific embodiments, many replacements, modifications, and variations of these embodiments will be apparent to those skilled in the art based on the previous description. For example, other memory architectures (such as Dynamic RAM (DRAM)) may use the discussed embodiments.

The above are only specific embodiments of this specification, but the scope of protection of the present disclosure is not limited hereto. Any changes or replacements that may be easily thought of by those skilled in the art within the technical scope disclosed by the present disclosure should be covered within the scope of protection of this disclosure. Therefore, the scope of protection of the present disclosure shall be based on the scope of the claims.

1. A method for automatically verifying full chip pin multiplex, comprising:
obtaining pin information that comprises a pin functional attribute and pin multiplex information;
generating an automatic verification process for pins based on the pin information; and
automatically verifying the pins one by one according to the automatic verification process generated for the pins.

2. The method according to claim 1, wherein obtaining pin information comprises automatically extracting the pin information from a pin multiplex design table.

3. The method according to claim 1, wherein the automatic verification process comprises a test sequence process for testing the functional attributes of the pins.

4. The method according to claim 3, wherein the automatic verification process further comprises a check sequence process for checking multiplex information of the pins.

5. The method according to claim 4, wherein the test sequence process and the check sequence process are executed synchronously.

6. The method according to claim 5, wherein automatically verifying the pins one by one according to the automatic verification process generated for the pins comprises:
assigning each pin to a test sequence number; and
performing the test sequence process on a pin and the check sequence process on the remaining pins if the test sequence number of the pin is the same as the current test sequence number; and performing the check sequence process on the pin if the test sequence number of the pin is different from the current test sequence number, wherein the current test sequence number indicates the test sequence number of the pin which is selected currently to undergo the test sequence process.

7. The method according to claim 1, further comprising determining whether the pin multiplex design table is updated; and reexecuting the foregoing method if the pin multiplex design table is updated.

8. A device for automatically verifying full chip pin multiplex, comprising:
a pin information acquisition module for obtaining pin information that comprises a pin functional attribute and pin multiplex information;
an automatic verification process generation module for generating an automatic verification process for pins based on the pin information, wherein the automatic verification process comprises a test sequence process and/or a check sequence process; and
a pin verification module for automatically verifying the pins one by one according to the automatic verification process for the pins.

9. The device of claim 8, wherein while obtaining the pin information the pin information acquisition module is further configured to automatically extract the pin information from a pin multiplex design table.

10. The device of claim 8, wherein the automatic verification process comprises a test sequence process for testing the functional attributes of the pins.

11. The device of claim 10, wherein the automatic verification process further comprises a check sequence process for checking multiplex information of the pins.

12. The device of claim 11, wherein the test sequence process and the check sequence process are executed synchronously.

13. The device of claim 12, wherein while automatically verifying the pins one by one according to the automatic verification process generated for the pins, the pin verification module is further configured to:
assign each pin to a test sequence number; and
perform the test sequence process on a pin and the check sequence process on the remaining pins if the test sequence number of the pin is the same as the current test sequence number; and performing the check sequence process on the pin if the test sequence number of the pin is different from the current test sequence number, wherein the current test sequence number indicates the test sequence number of the pin which is selected currently to undergo the test sequence process.

14. A non-transitory computer readable storage medium storing a computer instruction for enabling a computer to execute a method for automatically verifying full chip pin multiplex, the method comprises:
obtaining pin information that comprises a pin functional attribute and pin multiplex information;
generating an automatic verification process for pins based on the pin information; and
automatically verifying the pins one by one according to the automatic verification process generated for the pins.

15. The non-transitory storage medium of claim 14, wherein obtaining pin information comprises automatically extracting the pin information from a pin multiplex design table.

16. The non-transitory storage medium of claim 14, wherein the automatic verification process comprises a test sequence process for testing the functional attributes of the pins.

17. The non-transitory storage medium of claim 16, wherein the automatic verification process further comprises a check sequence process for checking multiplex information of the pins.

18. The non-transitory storage medium of claim 17, wherein the test sequence process and the check sequence process are executed synchronously.

19. The non-transitory storage medium of claim 18, wherein automatically verifying the pins one by one according to the automatic verification process generated for the pins comprises:
assigning each pin to a test sequence number; and
performing the test sequence process on a pin and the check sequence process on the remaining pins if the test sequence number of the pin is the same as the current test sequence number; and performing the check sequence process on the pin if the test sequence number of the pin is different from the current test sequence number, wherein the current test sequence number indicates the test sequence number of the pin which is selected currently to undergo the test sequence process.

20. The non-transitory storage medium of claim 14, wherein the method further comprises determining whether the pin multiplex design table is updated; and reexecuting the foregoing method if the pin multiplex design table is updated.
